(19) United States
(12) Patent Application Publication
(10) Pub. No.: US 2006/0080220 A1
(43) Pub. Date: Apr. 13, 2006

(54) Liquidity book system and method

(76) Inventors: Kevin Samuel, Locust Valley, NY (US); Stephen Braverman, Wantagh, NY (US); Mitchell Dinowitz, Dix Hills, NY (US)

Correspondence Address: OSTROLENK FABER GERB & SOFFEN, 1180 AVENUE OF THE AMERICAS, NEW YORK, NY, 100368403, US

(21) Appl. No.: 11/203,786

(22) Filed: Aug. 15, 2005

Related U.S. Application Data
(60) Provisional application No. 60/601,387, filed on Aug. 13, 2004.

(51) Int. Cl. G06Q 40/00

(52) U.S. Cl. 705/37

(57) ABSTRACT

A system is disclosed for providing services related to the securities industry to customers of broker-dealers. The system comprises a broker-dealer services module providing for at least one of indications of liquidity and/or interest, order entry, order management, and order crossing. The system further comprises a service transport media module enabling formulation of an electronic message provided in a first format as a function of at least one of an instant message, cellular text message, e-mail message, interactive voice response message, and a hypertext markup language message. The system further comprises a plurality of system components enabling implementing the services, the system components comprising one or more of a database, a messaging engine, an interface adapter, a client interface and an order clearing interface, wherein the system electronically receives the electronic message and substantially automatically transforms the message into a second format and executes commands represented in the electronic message.

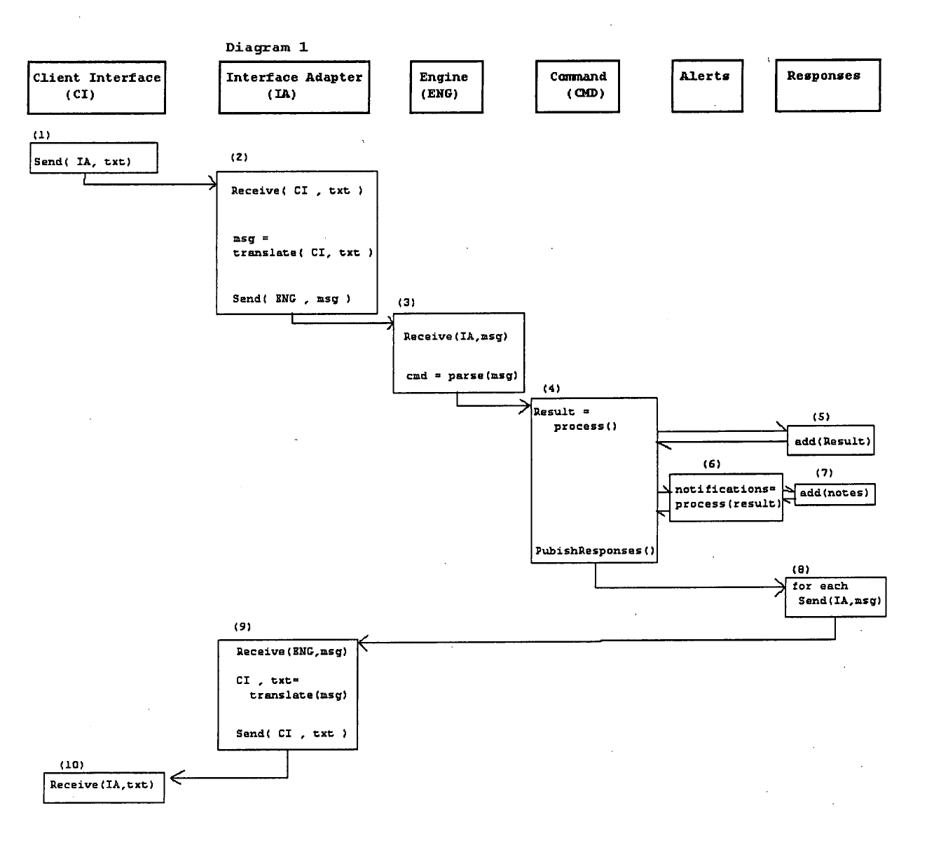

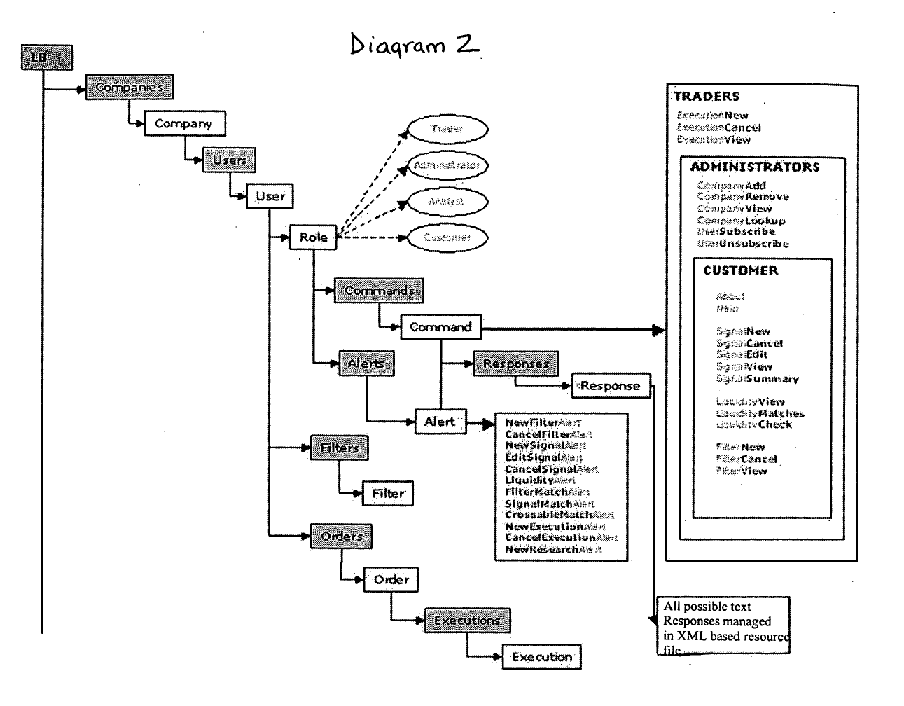

### CROSS-REFERENCE TO RELATED APPLICATION

This patent application is based on and claims priority to U.S. Provisional Patent Application Ser. No. 60/601,387, filed Aug. 13, 2004, entitled “LIQUIDITY BOOK SYSTEM AND METHOD,” the contents of which is incorporated herein by reference.

### BACKGROUND OF THE INVENTION

In the securities industry today, clients on the “buy-side” of the industry (investing institutions that tend to buy large portions of securities such as hedge funds, mutual funds, pension funds and insurances funds) face an overwhelming array of services offered to them by broker-dealers on the “sell-side” of the business (e.g., retail brokers, institutional brokers and research departments that sell securities and make recommendations for their customers). The result is that buy-side clients feel as if they are being deluged by too many service providers.

Competitive products exist in the prior art for each of the services listed in §I, below, however none of these prior art products provide all of the services in §I, below, via a plurality of transport mediums listed in §11, below.

### SUMMARY OF THE INVENTION

The present invention comprises a system and method for providing services related to the securities industry to customers of broker-dealers. In an embodiment a system comprises a broker-dealer services module providing for at least one of indications of liquidity and/or interest, order entry, order management, and order crossing. In this embodiment, the system further comprises a service transport media module enabling formulation of an electronic message provided in a first format as a function of at least one of an instant message, cellular text message, e-mail message, interactive voice response message, and a hypertext markup language message. In this embodiment, the system further comprises a plurality of system components enabling implementing the services, the system components comprising one or more of a database, a messaging engine, an interface adapter, a client interface and an order clearing interface, wherein the system electronically receives the electronic message and substantially automatically transforms the message into a second format and executes commands represented in the electronic message.

### BRIEF DESCRIPTION OF THE DRAWINGS

The structure, operation, and methodology of the invention, together with other objects and advantages thereof, may best be understood by reading the detailed description in connection with the drawings in which each part has an assigned either a label and/or numeral that identifies it wherever it appears in the various drawings and wherein:

Diagram 1 illustrates how messages are passed and processed within the invention; and

Diagram 2 illustrates classes employed by an embodiment of the present invention.

### DESCRIPTION OF THE INVENTION

The invention regards a system and method for providing various services to customers of a broker-dealer. Including, but not limited to the following:

§I. Broker-Dealer Services

A. Messaging
B. Indications of Liquidity/Interest
C. Order Entry/Management
D. Interest Filtering
E. Order Routing
F. Research Publishing
G. Order Crossing
   §II. Service Transport Media
A. Public/Private Instant Messaging (“IM”)
B. Cellular text-messaging
C. E-Mail
D. Interactive Voice Response (“IVR”)
E. World Wide Web (WWW)
F. Proprietary software installed on a client device
   §III. Service Components
A. Database
B. Messaging Engine
C. Interface Adapters
D. Client Interfaces
E. Order Clearing Interfaces
   §IV. User Roles Using Features, Such as in §I
A. Administrator
B. Trader
C. Customer
D. Analyst

The invention provides a broad array of means by which the services described herein may be offered to Customers. Many of the methods listed in §II, above, offer the advantage of being well-known mediums, which clients may use on a daily basis. Some, such as listed in §IIA, above, confer the advantage of requiring no additional screen space on the customer's computer display, which is typically cluttered with programs provided by various other service providers. The range of mediums listed in §II, above, also allows the invention to offer additional business value by providing an interface that is location independent by virtue of being able to ‘roam’ between various communication mediums.

The Roles listed in §IV, above, describe ways in which users/clients interact with the invention. As used herein, the terms “user” and “client” are used interchangeably to indicate any user who is capable of interacting with the invention. Also as used herein, the terms, “Administrator,” “Trader,” “Customer” and “Analyst” are used to denote specific capacities in which a user may interact with the invention.

Administrators perform general maintenance on the invention, including adding and removing users/companies.

Customers use the invention to take advantage of value-added services which the invention allows a broker-dealer to offer.

Traders are persons employed by, or associated with, the broker-dealer. Traders are responsible for supporting Customer interactions with the system (e.g. working orders placed through the system). Traders are also supported by the invention in that they have access to a greater amount of information provided by the invention than Customers do (e.g. Traders can see all orders, and the statuses thereof).

Analysts/Research Providers post research articles to the invention through the IM (or other) Interface Adapter, specifying those securities which are relevant to or affected by the articles. The Messaging Engine, upon receiving a translated message, forwards an article to any interested Clients (Customers or Traders).

An embodiment is now described with reference to an example. IM user johndoe123 sends a message ‘b1000xyz@mkt’ to the invention through an IMInterface Adapter, this message becomes ‘johndoe123.IM.b1000xyz@mkt’. Further parsing takes place within the Commands.

Continuing with the present example, Messaging Engine sends a message ‘johndoe123.IM.Received BUY 1000 XYZ@MKT’, the IM Interface parses johndoe123 as the recipient and forwards it to him or her. Note that the message may also contain formatting primitives which the Interface Adapter replaces with medium-specific formatting information. E.g. the formatting primitive {N} specifies a newline/carriage return. For an email interface, this would be replaced with a newline character, whereas for AOL Instant message or HTML format, it would be translated to <BR>. In a preferred embodiment of the invention, the Messaging Engine (§IIIB, above), Database (§IIIA, above), Interface Adapters (§IIIC, above) for each transport medium (§§IIA-F, above) with 3rd Party Client Interfaces (§IIID, above) are employed. Order Clearing Interfaces are optional, and may not form part of the preferred embodiment.

Particular information about individual Clients, (i.e., Company information, Personal and Transport Medium information, Past and Current Orders/Indications/Interests/Filters) and application state data are stored in the Database (§IIIA, above). Other components of the invention typically access the Database through the Messaging Engine. Moreover, the Messaging Engine accesses the Database through a Database Connectivity protocol (e.g., JDBC), the Messaging Engine may use an object-relational mapping engine to simplify DB access (e.g., Java Hibernate).

In a preferred embodiment, Clients send and receive messages/commands to the Messaging Engine through various Interface Adapters, which transform messages transported over a particular Transport medium (§§IIA-F, above) into a uniform proprietary or open transport independent format utilized by the Messaging Engine. The Messaging Engine replies to such messages through the Interface Adapters, which then transform the messages back from the independent format into an Interface-specific format, and deliver the transformed replies to Clients.

Diagram 1 illustrates how messages are passed and processed within the invention.

As shown in Diagram 1, the following steps occur:

(1) Client sends raw text message to invention via Interface Adapter;

(2) Interface Adapter receives raw text, translates it into a message and forwards it to the Messaging Engine;

(3) Engine receives message, and parses the appropriate Command, calls Command.process( );

(4) Command.process( ) performs its specified action, generating a Result;

(5) Result is added to the Responses Collection;

(6) Command.process( ) checks for any Alerts that may be generated for other Users by the Result;

(7) Alert Notifications are added to the Responses collection;

(8) Command.process( ) calls PublishResponses( ), which causes the Responses collection to be iterated to, with each Response being sent to the appropriate Interface Adapter;

(9) Interface Adapters receive messages, translate and format them into raw text and send them to the appropriate Client Interfaces; and

(10) Clients receive Response messages.

The Order-Clearing Interfaces includes two parts; local and remote. A Local Order Clearing Interface resides in or with the Messaging Engine, and serves to interface with the Order-Management System of the Broker-Dealer. A Remote Order Clearing Interface may include multiple instances residing at each Customer location or, when possible, a single instance residing in or with the Messaging Engine. The Remote Order Clearing Interfaces interact with each Customer's Order Management System. Each interface transforms messages to/from the various Order Management Systems (generally FIX protocol messages) into the same transport-independent format used by the Messaging Engine, allowing the invention to provide full Order-Management functionality to clients, as well as enhancing other services listed in §I, above.

Preferably, a Client sends a message to the IM Interface Adapter, which transforms the message into the Messaging Engine format and forwards it to the Messaging Engine (§IA, above). Upon receiving the message, the Messaging Engine forwards that message to the appropriate Client(s) through the IM Interface adapter, which re-transforms the message into IM Format and sends it to recipient. In cases where the Messaging Engine sends Customers or Traders Alerts about various conditions, the process is similar: the Messaging Engine preferably sends a message addressed to Clients through an IM Interface Adapter, which handles the translation and transmission of the message over the desired IM network.

Preferably, Clients are allowed to enter indications of Liquidity or Interest in a specific Security (§IB, above). Rules for various indications are configurable and contained in the Database. The rules include, but are not limited to: Anonymous Indications of Interest (where no order or other information is disclosed), and Firm Indications (in which an indication reflects a firm order placed with the broker-dealer; in such a case, indications are not entered directly by the Customer, but are automatically generated as a side effect when the Customer enters an Order). As noted above, a message originates as an IM message from the Client to the IM Interface Adapter, which presents a standardized message to the Messaging Engine. The Messaging Engine then stores the standardized indication, along with other relevant information (e.g., time, date, symbol, duration etc.) in the Database, and compares the indication to all existing indications and filters (§IF, above). Upon finding any matches (according to criteria defined in the Database), the Messaging Engine takes actions which are also specified in the Database, including, but not limited to: broadcasting the indication (or attributes thereof, e.g., symbol only, without size of price) to interested parties, effecting automatic trades (crosses) between eligible Clients and notifying Traders of potential or existing matches.

The broker-dealer may charge Customers a per-share or per-transaction fee for this service. Such fees may be higher than those for regular order executions through the invention, due to the added value presented by the discovery of natural liquidity when two orders are matched. Additionally, such fees may be different for the two parties involved in the trade (e.g. the first party to present an indication may receive a discounted commission rate).

Preferably, the invention allows clients to effectively manage orders placed with the deploying broker-dealer, including but not limited to: Order entry/modification/cancellation/status query (§IC, above). Clients have the facilities to enter all of these manually though the IM (or other) interface. To enter an order, a Customer preferably sends a message to the IM Interface Adapter (e.g., ‘b100000xyz@23.5gtc’). Upon receiving this message, the Messaging Engine records the order in the Database and forwards it to a Trader, who enters it into the broker-dealer's Order-Management System (OMS). The Customer may also enter the order in his own OMS. This method leverages the value created by automatic status queries and indications to present value to the Customer.

Moreover, this process is streamlined with the addition of Local and Remote Clearing Interfaces. Using these interfaces, the Messaging Engine forwards the order request to both its Local Clearing Interface, which preferably causes the order to be entered into the broker-dealers OMS automatically, and to the Remote Clearing Interface at the Customer's location, which automatically enters the order into the Customer's OMS. Local and Remote Clearing Interfaces are also be capable of polling or subscribing to the Broker-Dealer and Customer Order Management Systems to find and create Indications and Matches, as well as reverse-order entry (where the Customer enters an order with the broker-dealer through his OMS), and the Remote Clearing Interface is aware of this action and causes the order to be known to the Messaging Engine by sending a translated message to it. Local and Remote Order Clearing Interfaces can be used independently of each other (i.e., no Order Clearing Interfaces; Remote only, Local only, Local and Remote).

The broker-dealer may charge Customers a per-share or per order fee for this service.

Preferably, other services are available, such as allowing a Customer to specify a list of equity symbols in which he is interested (§ID, above). These symbols are preferably stored in the Database by the Messaging Engine, having received translated messages through the IM Interface Adapter. In situations including, but not limited to the publishing of indications and research (§§IB and IF, above), the Messaging Engine consults these lists of interests and uses them to decide whether or not to forward given message to a given Customers (e.g. Customer ‘A’ has a Filter for symbol XYZ, but not for symbol BTD. If Customer ‘B’ entered an Order/Indication/Research article for symbol XYZ, Customer A would receive a notification, for symbol BTD, Customer A would receive no notification).

Filters are also used by the invention, for example, during interactions with Traders and Analysts. Filters are preferably used to associated a Trader with a particular equity symbol, such that any messages related to equities for which a Trader has a Filter are forwarded to that Trader (e.g., the Trader is Filtered on BTD, when a Customer enters an order in BTD, the Trader with the filter is notified of the action). Traders are also able to create Filters for Customers, such that a Trader may be associated with a particular Customer and thus be the primary/default party to receive notifications for that Customer. When associated in such a way, Traders with overlapping Filters may be prioritized such that one Trader is designated the ‘Primary’ association for a given symbol or Customer, and others are designated ‘Secondary’, ‘Tertiary’ etc.

The Database is preferably configurable by the Administrator to forward messages to any or all Traders/Customers based on customizable criteria (e.g., forward messages to all Traders, or only to the first Trader who has a Filter and is available, in order of priority).

Section IE is a subset of Section IC, and requires a Local Order Clearing Interface, a Remote Order Clearing Interface is still optional.

A Customer enters an order with specific routing information to buy or sell a security to the IM Interface Adapter. Upon receiving the message, the Messaging Engine immediately sends a message to the Local Order Clearing Interface, which causes the broker-dealers OMS to route the order appropriately (e.g., the order may be routed directly to the floor of the NYSE via DOT or a floor broker, or on NASDAQ via a small order execution system (“SOES”). The Messaging Engine further directs the Remote Order Clearing Interface to pick up the contra side of the trade, and may notify the Customer of the status of the trade in real-time through the IM Interface Adapter. The broker-dealer may charge a per-share or per-transaction commission to the Customer for this service.

Preferably, (§IF, above) Customers receive targeted information (published by a User/Analyst) from the invention (§IF, above), Customers may be charged a fee for such information, which may be paid to the broker-dealer and/or Analyst.

Order Crossing (§IG, above) may be done automatically (implying ECN/ATS functionality) or manually.

In a manual implementation, the Messaging Engine identifies crossable orders that have been entered (Buyer and Seller with compatible prices), and then notifies a Trader and/or the Customers who entered the order that a potential cross exists.

Preferably, the Customers are enabled to negotiate the cross via Messaging (§IA, above), in which both parties will remain anonymous.

The Trader may negotiate with the customers through Messaging or any other media (e.g. Telephone).

In an automatic implementation, once a potential Cross has been identified, the Messaging Engine is operative to automatically generate any necessary trades to effect the Cross by sending appropriate messages to the Local and Remote Order Clearing Interfaces. The invention preferably determines the price and size at which the Cross is affected via algorithms stored in the Database (e.g., cross 10% of the smaller order size at a price mid-way between that of the buyer and seller).

Both Customers will receive notifications when a Cross takes place. The broker dealer may charge a per-share or per transaction fee for this service; as with §IB, above, the Customers may be charged at different rates.

The Database(§IIIA, above) is preferably an SQL RDBMS with proprietary schema mapped to the Object model used by the Messaging Engine (§IIIB, above). The preferred embodiment may store information both within the SQL RDBMS and within the code of the Messaging Engine or other components. In either case, the information is considered to reside with ‘the Database’ for the purposes of the teachings herein.

The preferred embodiment of the invention is a Java class collection comprising/representing:

1. Messaging Engine
i. The Messaging Engine feeds incoming messages to a CommandTree associated with a particular User/Role. The CommandTree parses the message into a particular Command, which generates responses that are published to the appropriate users (messages are passed through an Interface Adapter in each direction).
ii. The Message Pump also services messages from, and publishes messages to Order Clearing Interfaces.

2. Companies
i. Companies are associated with users on a one to many basis, each Company object contains contact and account information for the company it describes.

3. Users
i. Each User represents an employee/associate of a particular company. A User has a Role that describes the Commands available to it. A User can be associated with numerous Client Interface Adapters.

4. Roles
i. Each Role contains the Commands and Alerts that define how the User having that role interacts with the invention.

5. Filters
i. Each User can have any number of filters which limit the Alerts received by that User.

6. Orders
i. Each User can enter/edit/cancel Orders for his company, any of these actions may generate an Alert.

7. Executions
i. Each Order may have multiple Executions, an Execution describes a portion of an Order that was filled, and includes a descriptor of the Order, as well as the symbol, size, price and commission at which the fill was made.

8. Alerts
i. Each Role contains various alerts which describe the situations in which the associated user will receive a notification message from the invention (e.g. on order creation or cancellation, or on the publishing of new research).

9. Commands
i. Each Role contains a set of Commands available to the associated user. (e.g. enter/edit/cancel orders, create/remove filters etc.).

10. Responses
i. Each response consists of a specific message with formatting data and an associated User (e.g. “Your Order to Buy 10,000 XYZ@12.50 was accepted as ID #12” or “Order#12-BOT 1000XYZ@12.50; 1000XYZ@12.50 LVS 9000”).

11. Interfaces
i. Each Interface class represents a different transport medium listed in §11, above, or a different vendor within a medium (e.g. AOL IM Interface and Yahoo IM Interface).
ii. Each Interface is associated with various Users on a many-to-many basis (i.e. a User may be associated with many interfaces, and each Interface is associated with many Users).
iii. Each Interface feeds messages to the Messaging Engine for processing, and the Messaging Engine then uses the appropriate Interface to publish Responses to each User.

The preferred embodiment of a Client Interface Adapter (§IIIC, above) is as an Interface object associated with a User object in the Messaging Engine. However, the Client Interface Adapter may also consist of a separate application. In either case, the Client Interface Adapter serves as a bi-directional translator between various media formats and the Messaging Engine's message format.

The preferred embodiment of Client Interface (§IIID, above) is provided in a 3rd party application, e.g. IM Client, Cell phone with SMS or email application.

The preferred embodiment of the Order Clearing Interface provided in (§IIIE, above) is provided such that the Local implementation is an OrderClearing Object in the Messaging Engine. This object will handle communications with the broker-dealers OMS, as well as with the remote Order Clearing Interfaces. The Remote Implementation may be a standalone application to interface with a Customers OMS, or may be an object within the Messaging Engine.

The following describes an embodiment of the present invention. Details provided therein are made in terms of possible User inputs and Responses.

Commands

Each user has a root Command Node, from which parsing of commands begins. Certain types of users (e.g. Customers, Traders) may have different commands available, and thus different root nodes.

From each root, individual Commands are grouped by class (e.g. Company, User, Signal, Execution, etc.) To one skilled in the art, it should be apparent that all Command classes are presented in Java ‘Camel-Case’, and that the second capitalized word of each command represents the logical grouping/class upon which the Command operates, and the third word represents the action performed. Each group contains a number of ‘leaf nodes’, which represent actions which may be performed; A root or group node can have group or leaf nodes as children, but a leaf node cannot have any children. This tree structure is ‘walked’ by the invention to parse incoming commands from users, and also in the help display, described below.

Help and About commands are available to all users.

CommandAbout

User enters command ‘a’ or ‘about’, the invention will return a message describing itself.

CommandHelp

The invention will display a menu of available commands, grouped by class. To select an item from the menu, the user can select either the ordinal number associated with each group/command, or type in the command itself. Once the user has selected a group, the menu will then display the actions available in that group (e.g. if the user selects the ‘Company’ help, he will then have the option of seeing the help for either adding or removing a company). The invention will maintain the current menu position of the user in the Database.

Company and User related commands are only available to Administrators and Traders.

### Example 1

| | | |
|---|---|---|
| Input: | help | |
| Output: | Help −> | Main Menu |

| | |
|---|---|
| (11) | Orders |
| (12) | Executions |
| (13) | Filters |
| (14) | Liquidity |

### Example 2

| | | |
|---|---|---|
| Input: | 1 | |
| Output: | Help −> | Main Menu −> Orders |

| | |
|---|---|
| (0) | Back |
| (1) | Placing Orders |
| (2) | Changing Orders |
| (3) | Canceling Orders |
| (4) | Order List |
| (5) | Order Recap |
| (6) | About Orders |

### Example 3

| | |
|---|---|
| Input: | 1 |
| Output: | Help −> Main Menu −> Orders −> Placing Orders |

To place an order, type
ON[direction][size][symbol][price][qualifiers] where:
[direction] is a one letter code; (B)uy, (S)ell or Shor(T)
[size] is the number of shares
[symbol] is the mnemonic for the desired security
[price] is either a double-precision number, or ‘MKT’ for market orders
[qualifiers] is any one or several of: GTC, IOC, FOK

CommandCompanyAdd

User enters a Company into the invention, which stores it in the Database. Information stored includes the full name, a short name (mnemonic), address and other contact information.

### Example

| | |
|---|---|
| Input: | cn COMP |
| Output: | Company COMP added to system. |

CommandCompanyRemove

User removes a Company from the invention, which either deletes it from the Database, or marks it as not in current use.

### Example

| | |
|---|---|
| Input: | cc COMP |
| Output: | Company COMP removed from system. |

CommandUserSubscribe

User adds another User to the invention, which stores it in the database. Information used includes: Name, screen name, Role type, network name and company.

### Example

| | |
|---|---|
| Input: | us JOHN customer COMP |
| Output: | Customer JOHN of COMP added to system. |

CommandUserUnsubscribe

User removes another user from the invention, which either deletes it from the database or marks it as no longer in use.

### Example

| | |
|---|---|
| Input: | uu JOHN |
| Output: | Customer JOHN of COMP removed from system. |

The invention publishes a list of stored Companies to the user.

### Example

| | |
|---|---|
| Input: | cv |
| Output: | Companies View: |

| | |
|---|---|
| (1) | COMP |
| (2) | ACOM |
| (3) | BCOM |
| (4) | CCOM |

CommandCompanyLookup

This command must specify the desired company to look up. The invention will display detailed information about that company.

### Example

| | |
|---|---|
| Input: | cl COMP |
| Output: | Company Detail for COMP: |
| | Some Company |
| | 123 Some Street |
| | Some City, SS, 55555 |
| | Phone (555) 555-1234 |
| | FAX (555) 555-1235 |
| | Primary Contact: JOHN |

Signal-related commands are available to all users.
CommandSignalNew

User adds a new Signal, specifying all necessary attributes of the order, including symbol, size and price. The invention will store the Signal in the database, and send a confirmation to the User, as well as appropriate Liquidity/IOIs to other Users, Traders will be notified of the order in detail, as well as any other orders which might match or cross the new order. Traders may enter order on behalf of a Customer if so directed.

### Example

| | |
|---|---|
| Input: | onb1000xyz100gtc (input by Customer JOHN) |
| Output: | Order #123 to BUY 1000XYZ@100 GTC received. |
| To Trader: | New Order: |
| | JOHN@COMP |
| | B1000XYZ@100 GTC |
| To Customer with | There is Liquidity in XYZ. |
| Filter in XYZ: | |

CommandSignalCancel

User cancels a previously entered signal, receives cancellation confirmation.

### Example

| | |
|---|---|
| Input: | oc123 |
| Output: | CANCELLED Order 123: |
| | B1000XYZ@100 GTC |
| | 0 Done @ 0, LVS 1000 |

CommandSignalEdit

User modifies a previously entered signal, receives edit confirmation. If the edit affects the possible matches or crosses of the order, the invention will notify interested Users as if it were a new order.

### Example

| | |
|---|---|
| Input: | oe123q + 1000 |
| Output: | MODIFIED Order 123: |
| | Quantity + 1000, now |
| | B2000XYZ@100 GTC |

CommandSignalView

The invention will return an overview list of all outstanding and day orders for the User.

### Example

| | |
|---|---|
| Input: | ov |
| Output: | Order View: |
| | (123) B2000XYZ@100 GTC |
| | (124) S50000MOT(@)MKT |

CommandSignalSummary

The invention will return a detailed summary of the order specified.

### Example

| | |
|---|---|
| Input: | os123 |
| Output: | SUMMARY Order 123: |
| | B2000XYZ@100 GTC |
| | DONE 1000 @ 99.5 LVS 1000 |

Execution Commands are only available to Traders.
CommandExecutionNew

Trader enters a new Execution for an order. The Execution details a partial or complete fill of the order (e.g. for an Order to Buy 500 IBM@100, a Trader might buy 100@99 on the NYSE floor, and create a new Execution for 100IBM@99). Other Traders and the User who owns the order will all be notified of the Execution.

### Example 1

| | |
|---|---|
| Input: | pn123 500 100 |
| Output: | New EXECUTION #1 for Order #123 |
| | BOT 500 XYX @ 100 |
| | DONE 500 @ 100 LVS 1500 |

### Example

| | |
|---|---|
| Input: | pn123 500 99 |
| Output: | New EXECUTION #2 for Order #123 |
| | BOT 500 XYZ @ 99 |
| | DONE 1000 @ 99.5 LVS 1000 |

(the Customer upon whose behalf the Order is being Executed will receive the same confirmation)
CommandExecutionCancel

Trader cancels a previously entered Execution, receives cancellation confirmation.

### Example

| | |
|---|---|
| Input: | pc2 |
| Output: | CANCELLED Execution #2 for Order#123 |
| | WAS: BOT 500 XYZ @ 99 |
| | NOW: DONE 500 @ 100 LVS 1500 |

CommandExecutionView

Trader specifies an order, invention returns a detailed list of all Executions associated with that order.

### Example

| | | |
|---|---|---|
| Input: | pv123 | |
| Output: | Order#123: | B2000XYZ@100 GTC |
| | Print#1: | BOT 500 XYZ @ 100 |
| | Print#2: | BOT 500 XYZ @ 99 |
| | DONE: | 1000 @ 99.5 LVS 1000 |

Liquidity-related Commands are available to all Users.
CommandLiquidityView

Invention returns a list of all available Liquidity. The level of detail in the list may be varied by User Role.

### Example

| | |
|---|---|
| Input: | lv |
| Output: | There is currently Liquidity in: |
| | XYZ |
| | MOT |
| | IBM |

CommandLiquidityMatches

Invention returns a list of the available Liquidity which is the Union of the set of all Liquidity and the set of that Users Filters.

### Example

| | |
|---|---|
| Input: | lm |
| Output: | Your matching Liquidity is: |
| | XYZ |
| | MOT |

CommandLiquidityCheck

User specifies a specific symbol, invention returns a Boolean indication as to whether or not there is available liquidity in that symbol.

### Example

| | |
|---|---|
| Input: | lcZQK |
| Output: | There is currently NO Liquidity in ZQK |

### Example

| | |
|---|---|
| Input: | lcIBM |
| Output: | There is currently Liquidity in IBM. |

CommandFilterNew

User enters a new Filter, which the invention stores in the Database along with an association to that User. User receives a confirmation of the new Filter.

### Example

| | |
|---|---|
| Input: | fnIBM |
| Output: | Filter (IBM) Added. |

CommandFilterCancel

Invention removes the specified Filter from the Database, user receives a cancellation confirmation.

### Example

| | |
|---|---|
| Input: | fcIBM |
| Output: | Filter(IBM) Removed. |

CommandFilterView

User receives a list of all currently active Filters.

### Example

| | |
|---|---|
| Input: | fv |
| Output: | Your Active Filters: |
| | IBM |
| | MOT |

Alerts:

In addition to receiving responses to sent Commands, Users may also receive Alert messages from the invention. Each Role has a set of Alerts, which may be received by Users possessing that Role.

Users may configure their Alerts at several levels of granularity, including, but not limited to:

Filtering of all Alerts by certain criteria, such as related User, Company or symbol.

Filtering of individual Alerts by certain criteria, such as related User, Company or symbol.

Alerts may also be grouped into an Alert ‘portfolio’ which may be assigned to a list of Users, Alerts within a ‘portfolio’ may be sent to either every User in its list, or only to the first available User in a prioritized list (e.g. all Alerts for Traders may be grouped together into a portfolio and assigned a prioritized list of Traders, only the first available Trader in the list would receive any of the Alerts in the ‘portfolio’).

Multiple Users may receive the same Alert. Additionally, multiple types of Alerts may be triggered by the same event.

Possible Alerts include, but are not limited to, the following:

(Note: examples assume a Customer named ‘C1’ associated with Company ‘COMP’).

NewFilterAlert

Triggered by creation of a Filter, received by Traders.

### Example

C1 of COMP has entered a Filter in XYZ.

CancelFilterAlert

Triggered by cancellation of a Filter, received by Traders.

### Example

C1 of COMP has cancelled a Filter in XYZ.

NewSignalAlert

Triggered by creation of an Order, received by Traders.

### Example

New Order by C1 of COMP:Ticket #001 BUY 10,000 XYZ@33.40 GTC

EditSignalAlert

Triggered by modification of an Order, received by Traders.

### Example

| Order #001 Changed by C1 of COMP: | |
|---|---|
| FROM: | BUY 10,000 XYZ @ 33.40 GTC |
| TO: | BUY 12,000 XYZ @ 33.54 GTC |

CancelSignalAlert

Triggered by cancellation of an Order, received by Traders.

### Example

Order #001 Cancelled by C1 of COMP

LiquidityAlert

Received by Customers; this Alert is triggered when a new Signal represents the first new Signal for a given symbol that is not owned/entered by the Customer or Company to whom the Alert is being sent, and matches either an existing Order in that symbol which IS owned by that Customer/Company, or matches a Filter of the Customer/Company.

e.g. take Customers C1, C2 and C3 of different companies.

C2 has a Filter in XYZ.

C1 enters an Order in XYZ.

C2 gets a LiquidityAlert for XYZ.

C3 gets no Alert.

C3 enters an Order in XYZ.

C2 gets no Alert, as he has already been notified of Liquidity in XYZ.

C1 gets a LiquidityAlert for XYZ.

C3 gets a LiquidityAlert for XYZ, because his Order now matches C1's Order.

### Example

There is Liquidity in XYZ.

FilterMatchAlert

Triggered when a new Order matches a User Filter, received by Traders.

### Example

C2 of CORP has a FILTERED MATCH in XYZ

With Ticket#001: B10,000XYZ@33.40 GTC by C1 of COMP

SignalMatchAlert

Triggered when a new Order matches (but does not cross) an existing Order, received by Traders.

Two Orders are said to ‘Match’ when they have the same Symbol and opposite sides of the trade (i.e. Buyer and Seller), but the prices do not cross (i.e. Buyers offer less than Sellers ask).

### Example

SIGNAL MATCH:

Ticket #001: B10,000XYZ@33.40 GTC by C1 of COMP

With

Ticket #002: S5,000XYZ@33.50 by C2 of CORP

CrossableMatchAlert

Triggered when a new Order crosses an existing Order, received by Traders.

Two Orders are said to be ‘Crossable’ when they have the same Symbol and opposite sides of the trade, and prices either cross or are potentially crossable (i.e. Buyers offer is greater than or equals to Sellers ask, or either order is a market order).

### Example

CROSSABLE MATCH:

Ticket #001: B10,000XYZ@33.40 GTC by C1 of COMP

With

Ticket #002: S5,000XYZ@MKT by C2 of CORP

NewExecutionAlert

Triggered when a new Execution is created for an Order, received by Customers and Traders.

### Example

New Print #001 for Ticket #001:

BOT 1000 XYZ@33.35 C.01

DONE 1000@33.35 LVS 9000

CancelExecutionAlert

Triggered when an Execution is Cancelled, received by Customers and Traders.

### Example

Cancelled Print #001 for Ticket #001:

CXL BOT 1000 XYZ@33.35 C.01

DONE 0@0 LVS 10000

NewResearchAlert

Triggered when a research article is published through the invention, received by Customers and Traders.

Research Alert:

XYZ projected earnings $1.03 per share. STRONG BUY.

Thus, the present invention provides improved services to customers of a broker-dealer. Other uses and products provided by the present invention will be apparent to those skilled in the art. Although the present invention has been described in relation to particular embodiments thereof, many other variations and modifications and other uses will become apparent to those skilled in the art. It is preferred, therefore, that the present invention be limited not by the specific disclosure herein

What is claimed is:

1. A system for providing services related to the securities industry to customers of broker-dealers, the system comprising:
a broker-dealer services module providing for at least one of indications of liquidity and/or interest, order entry, order management, and order crossing;
a service transport media module enabling formulation of an electronic message provided in a first format as a function of at least one of an instant message, cellular text message, e-mail message, interactive voice response message, and a hypertext markup language message; and
a plurality of system components enabling implementing the services, the system components comprising one or more of a database, a messaging engine, an interface adapter, a client interface and an order clearing interface, wherein the system electronically receives the electronic message and substantially automatically transforms the message into a second format and executes commands represented in the electronic message.

2. The system of claim 1, wherein the order clearing interface further comprises a local order clearing interface and a remote order clearing interface, wherein the local order clearing interface and the remote order clearing interface transform messages to/from the first format into the second format.

3. The system of claim 2, wherein the local order clearing interface communicates with a broker's order management system and the remote order clearing interface communicates with the customers' respective order management systems.

4. The system of claim 3, wherein the messaging system forwards order requests to the local clearing interface, and the local clearing interface causes the order requests to be entered into at least one broker-dealer's order management system substantially automatically.

5. The system of claim 3, wherein the messaging system forwards order requests to the remote clearing interface, and the remote clearing interface causes the order requests to be entered into at least one customer's respective order management systems substantially automatically.

6. The system of claim 2, wherein the local clearing interface and the remote clearing interface to poll at least one of the broker-dealers' order management systems and the customers' order management systems to identify and/or create at least one of indications and matches, reverse-order entry.

7. The system of claim 1, wherein the database stores electronic information representing customers, brokers and rules for indications of liquidity or interest in a specific security, and further wherein the system matches the rules with the customers and brokers.

8. The system of claim 7, wherein the messaging engine takes actions specified in the electronic information that include at least one of broadcasting at least one of the indications, effecting automatic trades and notifying the customer and/or broker-dealers of the effected trade.

9. The system of claim 1, wherein the system components enable customers to manage orders placed with the broker-dealers.

10. The system of claim 9, wherein the customers manage at least one of order entry, order modification, order cancellation and order status.
